(19) United States
(12) Patent Application Publication
(10) Pub. No.: US 2008/0222344 A1
(43) Pub. Date: Sep. 11, 2008

(54) Facilitating Integration of a Virtual Tape Library System with a Physical Tape Library System

(76) Inventor: Shivarama Narasimha Murthy Upadhyayula, Bangalore (IN)

Correspondence Address: Shivarama Narasimha Murthy U, 9/2 (10/9), SapthaNilaya Apartments,, 3rd Temple Street, 15th Cross, Malleshwaram, Bangalore, 560003, omitted

(21) Appl. No.: 12/044,564

(22) Filed: Mar. 7, 2008

(30) Foreign Application Priority Data
Mar. 8, 2007 (IN) 481/CHE/2007

(51) Int. Cl. G06F 12/00

(52) U.S. Cl. 711/4; 711/E12.001

(57) ABSTRACT

Facilitating integration of a virtual tape library system with a physical tape library system. A virtual library tape (VTL) system acts as an intermediary between a physical library tape (PTL) system and a backup host, such that the backup host is always aware of, and can manage the media present in the VTL and also in the PTL. Exporting of data from a virtual tape to a physical tape is performed by the VTL system for high performance. Also a one to one mapping exists between the virtual tape barcode label and the physical tape barcode label, thereby facilitating restores directly from physical tape.

### BACKGROUND

1. Technical Field

The present disclosure relates to backup systems, and more specifically for facilitating integration of a virtual tape library system with a physical tape library system.

2. Related Art

Traditional backup methods involved writing data on to data storage tapes for longer archival of data. Tapes are considered slower when compared to disk based storage. Virtual tape library (henceforth as VTL) systems emulate a tape based library system and to a backup host it would appear as a physical tape library (henceforth as PTL). However the data is backed up to a virtual tape rather than to a real physical tape. The virtual tape is usually a portion of disk on which backup data is written to and read from VTL systems thus achieve faster backups and restores. But there are problems with how a VTL system is currently deployed in an existing tape based backup/restore system.

In backups or restores the backup host (the system performing the backup or restore) usually identifies the media by means such as the barcode label of the media as reported by the physical tape library system. VTL systems also present their virtual tapes with a barcode label. This barcode label can be the same as some physical tape in a tape library system present in the network. However a backup host can face problems when it sees the same barcode label for two different media at the same time. VTL systems take different approaches to override this problem. Another factor which influences the VTL deployment method is that the backup host maintains a catalog of the data backed up and this catalog is generally associated with a volume identifier written on tape. The volume identifier in general is associated with the barcode label of a tape.

In one prior approach, the backup host writes to virtual tapes in a VTL system during its normal backup cycles. Restores are performed from the virtual tapes if they are present in the VTL system. If the data on the virtual tape is required for archival then the backup host copies the data on the virtual tape to a physical tape within a physical tape library. The backup host can view and access both the VTL and the PTL systems. The barcode labels for the virtual tapes and the physical tapes are different, since the backup host can see both systems. Problems with the standalone deployment is that, there is more processing for the backup host since it has to perform the copy of data from the virtual tape to the physical tape. Also data copy operation may traverse the same data path, which is used to perform the regular backup operations. However media management is simpler since the backup host is always aware of the media in the backup topology and also about the contents of each media used for backup/restore.

In another approach a backup host in configured to only access the VTL system. The PTL system is hidden from the backup host's view. The backup host can however access the physical tape drive independent of the PTL robotics. Data copy to a physical tape from a virtual tape is done by the VTL system. The advantage of this approach is that the copy of data from virtual tape to a physical tape can happen in a dedicated data path between the VTL and the PTL system. However the backup host is unaware that about the copy operation and if during restores, the required virtual tape is no longer present, it would mean that the operator has to manually load the tape into a physical drive for the restore operation to succeed or as alternate, the data from the physical tape needs to be copied to a virtual tape with a matching barcode label before the restore operation can commence. Also if the target physical tape for the virtual tape copy has gone bad, the export operation from virtual tape to physical tape would fail. An option for this approach would be to run a client of the backup application on the VTL system itself. The backup application client on the VTL system would be in charge of the copying the data from the virtual tape to a physical tape and sending back information about the copy to backup application running on the backup host. The disadvantage is that this would need cooperation between the backup host's application and the backup application client on the VTL system, which might not be possible in a heterogeneous backup environment

Various aspects of the present invention facilitate integration of a virtual tape library system with a physical tape library system while addressing one or more problems/requirements described above.

### BRIEF DESCRIPTION OF THE DRAWINGS

Example embodiments of the present invention will be described with reference to the accompanying drawings briefly described below.

FIG. 1 is a schematic block diagram illustrating a tape library based backup system

FIG. 2 is a flow chart illustrating the logic for creating a mapped virtual element.

FIG. 3 is a flow chart illustrating the reporting of the status of an element in a VTL instance

FIG. 4 is a flow chart illustrating the steps performed when a VTL instance receives a media movement command.

FIG. 5 is a schematic block diagram illustrating a scenario with multiple VTL instances inter-connected with multiple backup hosts.

FIG. 6 is a schematic block diagram for the first embodiment of the invention

FIG. 7 is an illustration of the inventory returned to the backup host for illustration in FIG. 5

FIG. 8 is a flowchart describing the mapping of virtual elements in the first embodiment of the invention

FIG. 9 is a flowchart describing the command flow for virtual drives in the first embodiment of the invention

FIG. 10 is schematic block diagram for the first embodiment of the invention after media movement into virtual drives

FIG. 11 is an illustration of the inventory returned to the backup host for the illustration in FIG. 10

FIG. 12 is a flowchart describing the general principle followed when media is inserted into a PTL.

FIG. 13 is a flowchart describing the general principle followed when a media is to be ejected from a VTL instance.

FIG. 14 is a schematic block diagram for the second embodiment of the invention

FIG. 15 is an illustration of the inventory that would be returned for the illustration in FIG. 14

FIG. 16 is a schematic block diagram for the third embodiment of the invention

FIG. 17 and FIG. 18 are illustrations for the inventory returned to the backup host for the illustration in FIG. 16.

In the drawings, like reference numbers generally indicate identical, functionally similar, and/or structurally similar elements. The drawing in which an element first appears is indicated by the leftmost digit(s) in the corresponding reference number.

### DESCRIPTION OF EXAMPLE EMBODIMENTS

### 1. Overview

According to an aspect of the present invention, a virtual library tape (VTL) system acts as an intermediary between a physical library tape (PTL) system and a backup host, such that the backup host is always aware of, and can manage the media present in the VTL and also in the PTL. The export operation of transferring the data on a virtual tape to a physical tape is performed by the VTL. Also a one to one mapping exists between the virtual tape barcode label and the physical tape barcode label, thereby facilitating restores from physical tape in the absence of the virtual tape.

According to another aspect of the present invention, when a backup host queries the inventory of a VTL instance, not only the inventory of the VTL instance's virtual elements is returned, but also the inventory of the PTL is returned via the mapped virtual elements. Thus, physical elements in a PTL can be seen and managed by a backup host under the control of the VTL system. Mapped virtual elements in the VTL instance represent elements in the PTL.

According to yet another aspect of the present invention, barcode labels for media in mapped virtual elements are masked if a virtual tape with a matching barcode label exists in the system. Masking of barcode label for a mapped element would mean that on receipt of a element status command for the mapped element the response sent to a host would comprise of the following properties,
That there is no media in the mapped element,
That access to this mapped element is denied for media insertion or removal,
That the media barcode label in the mapped element is unknown;

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the features of the invention.

### 2. Elements of a Tape based Backup System

A backup host can be described as a host computer system, which performs backup of data to secondary storage such as disks, tapes etc. and restore of data when needed from the same. In the context of the invention, backup hosts can be divided into at least two types—backup host type ‘A’ and backup host type ‘B’.

Backup host type ‘A’ can associate a tape drive with storage slots. For example a tape drive 1 associated with storage slots 1-10, tape drive 2 associated with storage slots 10-20 etc. Media for tapes drive 1 use is only moved from slots 1-10 likewise, media for tape drive 2 is only moved from slots 10-20. Backup host type ‘B’ can associate media with tape drives based on media identifiers. For example barcode labels with prefix ‘ABC’ would be for tape drives of type ‘A’ and barcode labels with prefix ‘DEF’ would be for tape drives of type ‘D’

Barcode labels on tape cartridges are used to identify tape cartridges in the elements of a tape library. A tape library server returns the barcode label information for an element when asked for. It should be noted that media identification is not restricted to barcode labels only.

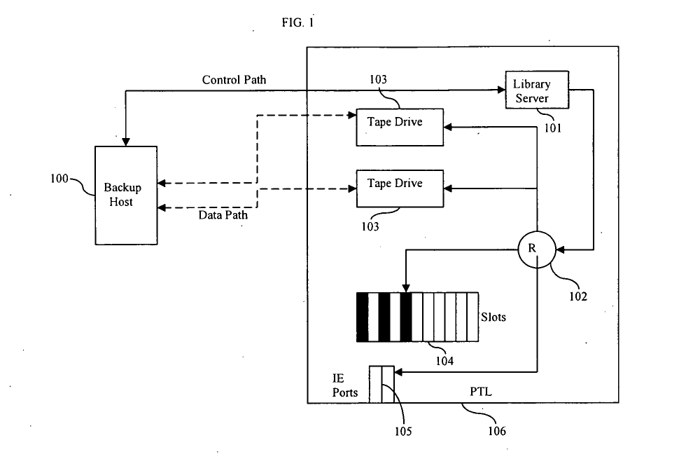

FIG. 1 shows a tape library backup system. In FIG. 1, the library server (101) is responsible for maintaining an inventory of the various elements of the library system and performing tasks such as media movement when requested by the backup host. The backup host (100) interacts with the library server (101) to get an inventory of the library and for media movement between the various elements of the library. The inter-connectivity between the library server (101) and the backup host (100) is generally termed as the control path.

The actual media movement is performed by the robot ‘R’ (102). FIG. 1 shows the tape drives (103) of the library system connected to the backup host (100). This inter-connectivity between the tape drive and the backup host is generally termed as the data path. FIG. 1 shows the Import/Export (henceforth as I/E) ports (105) where in an operator can place tape cartridges which can be moved in by the robot into one of the tape drives or storage slots. Tape cartridges can be removed from one of the storage slots (104) or tape drives (103) and place into the I/E ports (105), which can later be removed by an operator.

Tape cartridges can also be removed by opening a library door and manually removed from one of the storage slots (104), but during that time the library is generally considered as offline. Similarly tape cartridges can be inserted directly by an operator into one of the storage slots (104).

Some physical tape libraries support a concept of partitioning where a physical tape library can be partitioned into a plurality of logical tape libraries, each logical tape library with the ability of functioning as an individual tape library. To a host system and in this document to a VTL system, there is no deference between a physical tape library and a logical tape library. A physical tape library referred to in this document can thus either be an un-partitioned physical tape library or a logical tape library in a partition physical tape library

A VTL system is an independent computing system with its own processor(s), attached disk subsystem etc., connected and communicating with a plurality of backup hosts and also connected to and communicating with a plurality of physical tape library systems. The connectivity can be many means such as Fiber Channel, parallel SCSI, and Ethernet etc. The protocols used for communication are usually SCSI over Fiber Channel, iSCSI etc. Multiple computing systems can collectively form a single VTL system and usually termed as clustered VTL system.

A VTL instance in a VTL system virtualizes the elements of a tape library system such that to a backup host it would appear exactly as a PTL system. Multiple VTL instances can be created in a VTL system each with ability to emulate a physical tape library. A VTL system can be considered as a plurality of VTL instances. It should be noted that in this document the term physical tape is used to refer to the physical tape cartridges, and virtual tape is used to refer to a virtual tape cartridge. The virtual tape cartridge represents an allocation on disk for the virtual tape's use.

A mapped virtual element (henceforth as mapped element) is an element in a VTL instance, which represents a physical element in the PTL the VTL instance is associated with. The mapped element can be termed as a representative for the associated physical element.

A mapped element can be one of:
A mapped virtual storage slot, which represents a physical storage slot in the PTL
A mapped virtual tape drive, which represents a physical tape drive in the PTL
A mapped virtual I/E port, which represents an I/E port in the PTL.

The following names are used in the description and in the diagrams to identify the illustrated objects:

### VD1: Virtual Drive 1

### VD2: Virtual Drive 2

### PD1: Physical Drive 1

### PD2: Physical Drive 2

MD1: Mapped virtual drive1 mapped to PD1

### VS1: Virtual Slot 1

### VS2: Virtual Slot 2

### MS1: Mapped Virtual Slot 1

### MS2: Mapped Virtual Slot 2

VT1: Virtual tape with barcode label ‘LABEL1’
PT1: Physical tape with barcode label ‘LABEL1’
PT2: Physical tape with barcode label ‘LABEL2’
VT3: Virtual tape with barcode label ‘LABEL3’

### 3. Integrating a VTL System with a PTL System

The VTL system queries the physical tape library systems which are attached/accessible for an element inventory. Elements can be storage elements, tape drives, I/E ports and robots. A VTL instance in the VTL system is associated with an attached PTL system present or even a subset of the PTL system. By the association with a PTL, the virtual library system creates additional mapped elements to represent the physical elements in the associated PTL. For example, a mapped virtual storage slot is created to represent a storage slot in the associated PTL. On an inventory command received by a host, a VTL system reports the presence of the virtual elements and the mapped elements. To a host, the physical elements associated with the mapped elements belong to the VTL instance, although the physical elements belong to the PTL. It is assumed that the host is configured such that it does not communicate directly with the library server of the PTL

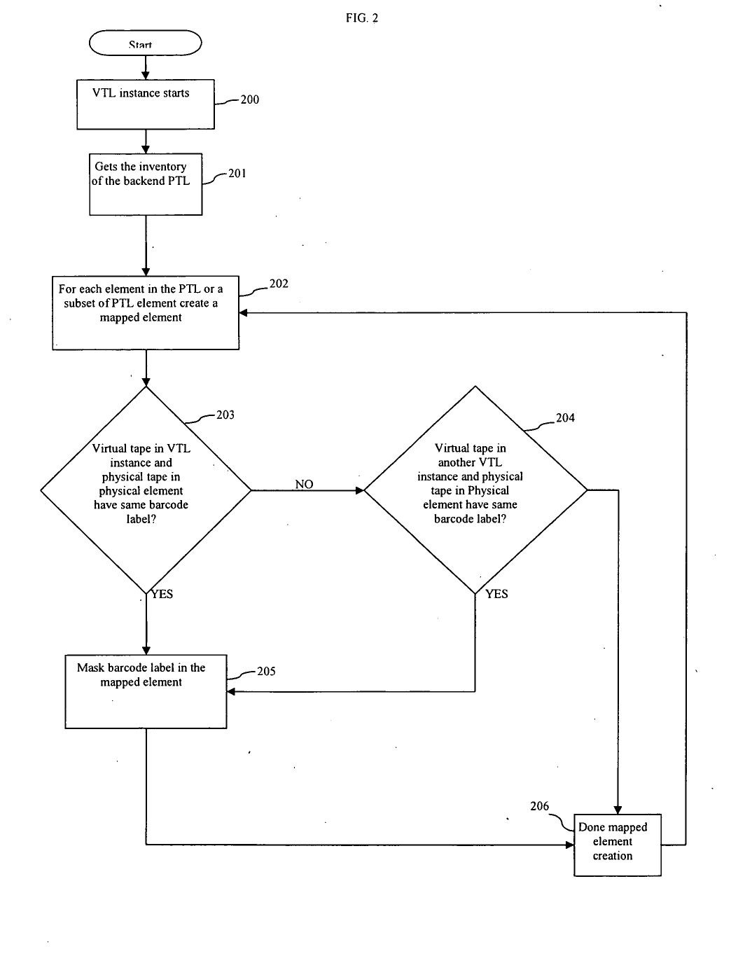

FIG. 2 is a flow chart illustrating how mapped elements are created in a VTL instance. It should be noted that the flowchart depicts a very generic logic. It should also be noted that the masking of the barcode label for a mapped element could also occur when a new virtual tape with matching label has been added to the VTL instance. Referring to FIG. 2, once a VTL instance starts as shown in block 200, the VTL instance receives the inventory of the PTL associated with the VTL instance as shown in block 201. It should be noted that the inventory could be fed to the VTL instance by the VTL server (described later in the specification). Given the inventory, for each element in the PTL, the VTL instance creates a mapped element and associates the mapped element with the physical element as shown in block 202. As shown in blocks 203, 204 and 205, if a virtual element in any VTL instance has the same barcode label as the media in a physical element, the barcode label for the mapped element corresponding to the physical element is masked.

When a mapped element is queried for its status by a backup host, the status reported is that of the corresponding physical element. In addition when mapped virtual drives are queried for device identifiers, the device identifiers of the mapped physical tape drives maybe returned to indicate to a host that the physical tape drives can be controlled by the VTL instance for media insertion/removal. Device identifiers are used by backup hosts to associate tape drives to a tape library.

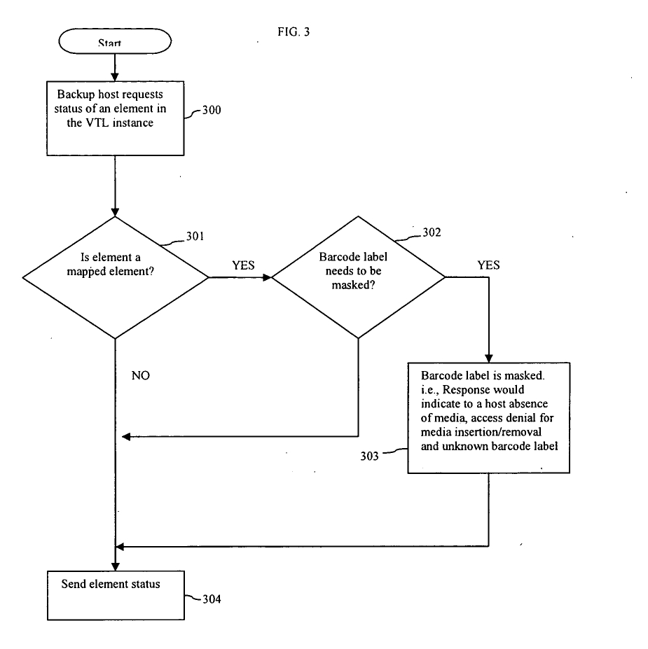

FIG. 3 is a flow chart illustrating the status sent to backup host when a VTL instance comprises of both virtual elements and mapped elements. On receipt of an element status command as shown in block 300, if the element is a virtual element as checked for in block 301, the status of the virtual element is returned by the VTL instance as shown in block 304. However if the element is a mapped element, then as shown in block 302, before sending the mapped element status the VTL instance checks if the barcode label needs to be masked for the element (maintained as an internal status for the mapped element by the VTL instance). If the barcode label does not need to be masked, the mapped element status maintained by the VTL instance is returned to the host. Else as shown in block 303, the response sent to the host is so modified which would indicate to a host that the mapped element contains no media, that access to the mapped element is denied for media insertion/removal and that the barcode label for the media in the mapped element is unknown.

All media movement is performed under the control of the VTL system. Depending on the embodiment of the invention, the host system can access the tape drives of the associated PTL either directly or through the VTL instance. The movement of media is performed by the backup host only through the VTL instance. The VTL instance has virtual medium changer(s) to which the backup host sends media movement requests.

If the source element of a move command is a virtual element and the destination is a mapped element, then the mapping for the destination virtual element is removed and if needed the mapping is assigned to another virtual element containing no virtual tape. The move command is then handled by the VTL instance. This step in detail comprises of:

1) locating a second virtual element which does not contain any virtual tape,
2) mapping the second virtual element to the physical element the destination mapped element corresponds to, thereby converting the second virtual element to a mapped element,
3) removing the mapping for the destination mapped element, thereby converting it to a destination virtual element,
4) performing the media movement between the source and destination virtual elements

It should be noted that in the above step the virtual element or mapped elements considered are either storage and import/export elements

If the source element of a move command is a mapped element and the destination element is a virtual element, for the destination element a mapping from one of the mapped elements containing no media is associated, the mapping for the previously mapped element removed and the move command is sent to the associated PTL for media movement between the corresponding physical elements. The mapping to a physical element for the destination virtual element can also be determined by an internal mapping maintained for the destination virtual element. This step is detail comprises of:

1) locating a mapped element for which the corresponding physical element contains no media
2) mapping the destination virtual element to physical element the mapped element corresponds to thereby converting the destination virtual element to a destination mapped element
3) removing the mapping for the mapped element and converting it to a virtual element
4) issuing a media movement command to the associated physical library to move media between the physical elements which the source and destination mapped elements correspond to

It should be noted that in the above step the virtual element or mapped elements considered are either storage and import/export elements

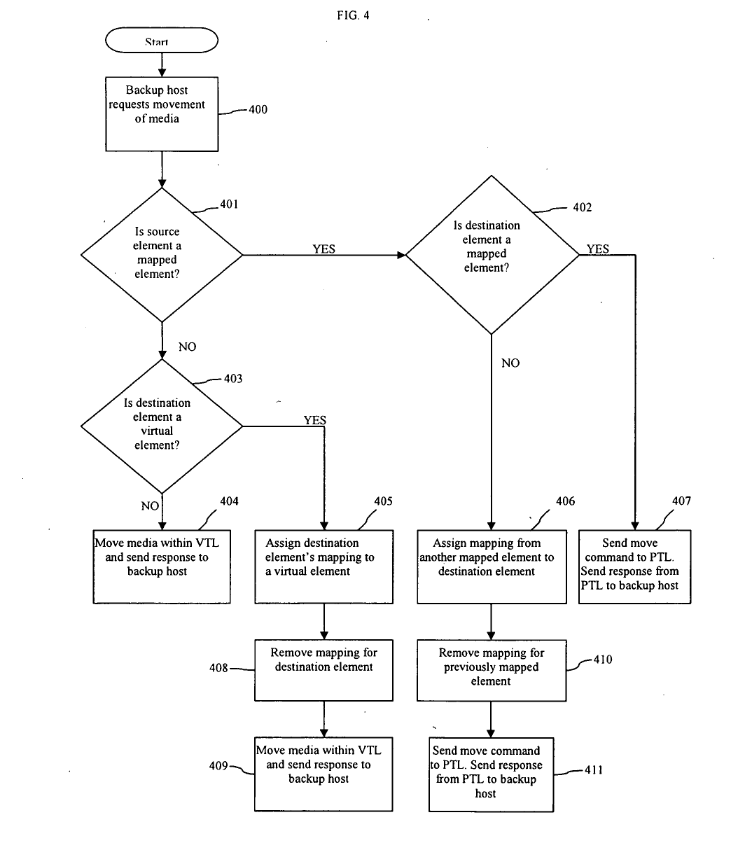

FIG. 4 is a flow chart illustrating the steps performed when a VTL instance receives a command for media movement from a backup host. When a media movement command is received, the VTL instance decides whether to move a virtual tape or relay the command to the associated PTL and send the response back to the backup host. For example if a move command is received to move a tape between two mapped elements, the move command is forwarded to the associated PTL. The PTL moves the media between the physical elements specified in the move command. The command response is sent back to the VTL instance, which sends the response back to the backup host. If a move command is received to move a virtual tape between two virtual elements, the VTL instance handles the command itself. A media movement command usually contains a source element address/identifier and a destination element address/identifier. The element address/identifier is used to locate the source and destination address. It should be noted that a mapped element address/identifier presented to a host in generally isn't the same with the element/identifier of the physical element the mapped element corresponds to. Relaying/forwarding the command to a PTL would additionally involve changing the element identifiers/addresses in the media movement command with the actual source and destination element address/identifier of the physical elements. As an alternate a new media movement command with the actual address/identifiers of the physical elements can be sent to the PTL, the response received and this response sent back to the host as the response for the original media movement command received by the VTL instance. A media movement command doesn't necessarily have a single source and a single destination address such as in the case of a SCSI EXCHANGE command, but the methods described for the media movement command would apply for a command with multiple source and destinations also.

Referring to FIG. 4, on receipt of a media movement command the VTL instance checks if the source element for the media movement is a mapped element as shown in block 401. If the source element is a virtual element then as shown in block 403, the VTL instance checks if the destination element is also a virtual element. If both the source and destination elements are virtual elements, the media movement is handled within the VTL instance and the response is sent back to the host as shown in block 404. If the source element is a virtual element and if the destination is a mapped element then the mapping of the destination element is mapped to an empty virtual element, the mapping for the destination element removed, the media movement performed with the VTL and the response sent back to the host (as shown in blocks 405, 408, 409). Likewise blocks 406, 410 and 411, illustrate the steps when source element is a mapped element but the destination is a virtual element. If the source and destination elements are both mapped elements, then the media movement command is sent to the associated PTL, the response is received and sent back to the host as shown in block 407

Media in library elements can have a barcode label. The barcode label is used by backup hosts to identify the media in a library element. Backup hosts can be confused by two different media containing the same barcode label. In the current invention since the physical elements of a PTL are presented as mapped elements in the VTL instance there might be a situation where a virtual tape and a physical tape have the same barcode label. The VTL instance avoids this situation as described.

If a virtual tape and a physical tape have the same barcode label, in the mapped element corresponding to the physical element containing the physical tape, the barcode label is masked. Access is denied to this mapped element for a backup host. Denying access to a mapped element would mean that a backup host couldn't move media out or move media into that mapped element. The barcode label sent as a response for element status command can be a sequence of zeros for the barcode label to indicate an unknown barcode label status. Also the response for an element status command would indicate that the mapped element contains no media and access to the mapped element for media/insertion removal itself is denied. Masking of the barcode label depends on internal status maintained by the mapped element.

### 4. Creating Multiple VTL Instances

Multiple VTL instances with different or same embodiments of the invention can be created on the same VTL system. As an example, a VTL instance can be considered as a software module instance running on the VTL system. Each VTL instance appears as a separate tape library to the backup host. The VTL instance has the ability to receive commands and send response to a backup host via the inter-connectivity between the backup host and the VTL system.

The VTL instances are independent of each other. However as the VTL instances need to communicate with their associated PTL(s) and VTL instances may be associated with the same PTL there is a need for a synchronized access to PTL. This would require that the VTL instances communicate with each other. Also in the case of a third embodiment of the invention described later two VTL instances work in pairs and need communication with each other. FIG. 5 illustrates a scenario where two VTL instances (501, 502) are running on the same VTL system and two backup hosts (100) communicate with each of the VTL instance. A VTL server module (503) is shown in FIG. 5. The tasks for a VTL server module would comprise of:
Read the inventory of the PTL(s) accessible by the VTL system on startup and periodically for inventory changes such as media insertions into the PTL etc. Update each of the mapped elements in the VTL instances with changes in a PTL inventory,
Receive media movement requests from a VTL instance and forward them to a PTL in a synchronized manner,
Handle device/element reservations as described later in the specification,
Scan new media inserted into a PTL to determine the type of media such as blank media, media which was prior exported etc,
Receive operator commands for masking of blank media, marking media as reusable etc,
On a successful virtual tape export, update the list of exported virtual tapes and the VTL instance they were exported from;
On a successful virtual tape export, update the list of exported virtual tapes in the virtual vault;

In general a virtual tape would have a barcode label unique across all VTL instances. If a virtual tape and a physical tape in a PTL have the same barcode label, for all VTL instances, which are associated with the PTL, the barcode label is masked for the mapped element representing the physical element containing the physical tape and access to the mapped element is denied for a backup host.

The virtual vault mentioned above can be termed as a location where information about virtual tapes exported from VTL instances is kept. On an export a virtual tape is removed from a VTL instance and the host would assume that the tape has been removed from the system. However a virtual tape can be later removed from the virtual vault and moved back to a VTL instance based on an operator request or on an import operation as described later in the embodiments of the invention.

### 5. Virtual Tape Creation

Another reason to mask barcode labels is when the media in physical element contains blank media or media marked as reusable specifically by an operator via a user configuration. A new virtual tape can be created with a barcode label matching a blank media. For example when a new virtual tape is to be created for a VTL instance the following steps are performed:
A blank media is searched for in all elements of the PTL.
A new virtual tape is created with a barcode label matching the blank physical tape.
The virtual tape is inserted into an empty virtual element.
During a backup, the host would write data to the virtual tape.
During export the VTL instance would copy the data to blank physical tape with the matching barcode label. Since the barcode label is masked for the physical tape the entire time the virtual tape exists, the host would only be aware of the virtual tape.
If the virtual tape was removed entirely from the VTL system and if the physical tape in inserted/exists in the PTL system, the barcode label of the corresponding mapped element would be unmasked and a backup host can now restore from the physical tape

Masking of barcode labels for blank or reusable media can be made as an operator configuration. If the barcode label for blank media were not masked, then a backup host might try to use a blank physical tape for data writes even if a blank virtual tape was available.

### 6. First Embodiment of the Invention

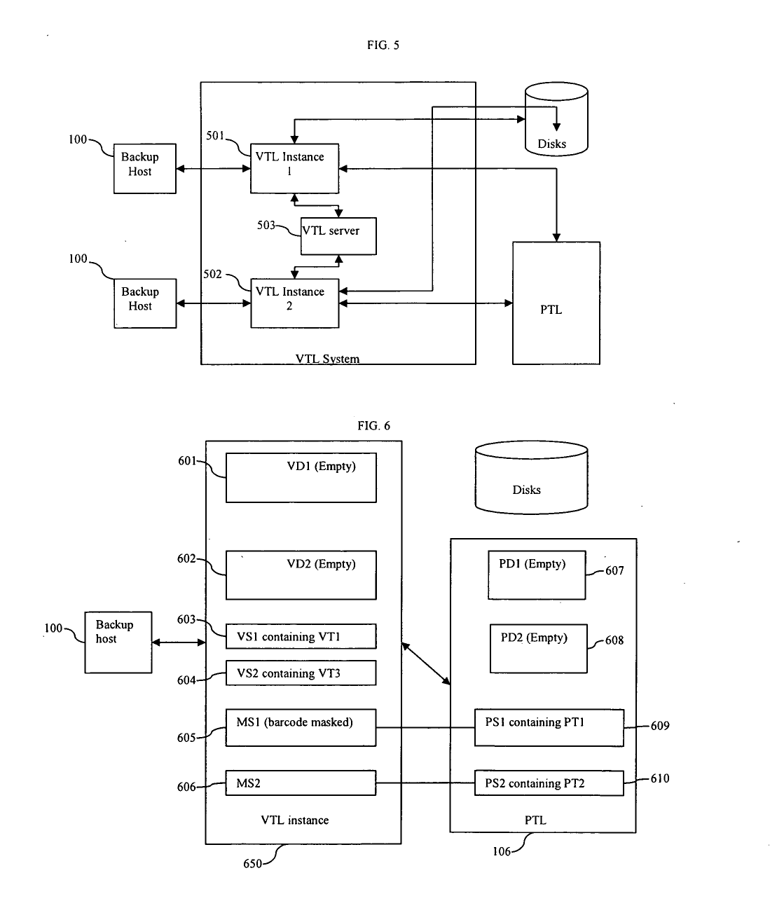

In a first embodiment of the invention, the virtual element and the mapped elements are combined to form a larger virtual library system as shown in FIG. 6. Media associated with each virtual element can either correspond to a virtual tape or mapped to a physical tape in the automated library system. Referring to FIG. 6, when backup host (100) queries the status of virtual storage slot VS1 (603), the status returned would indicate to host (100) that the storage slot contains media with barcode label ‘LABEL1’ (the virtual barcode label of virtual tape VT1). When the backup host (100) queries the status of mapped element MS1 (605), since the barcode label of the physical tape in physical slot PS1 (609) contains a barcode label ‘LABEL I’ and since there exists a virtual tape VT1 with the same barcode label, the barcode label is masked in the status returned to the host (100)

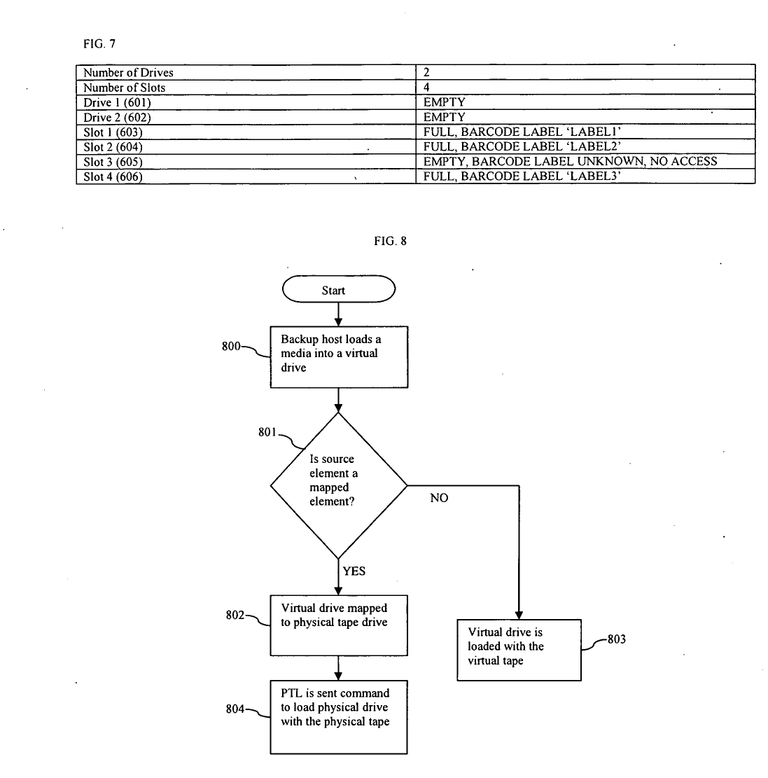

FIG. 7 shows an example of the inventory returned to a backup host for a VTL instance (such as shown in FIG. 6).

When the backup host tries to move a tape from a storage element to a tape drive in the VTL instance, if the storage element is associated with a virtual tape then the virtual tape drive gets associated with the virtual tape. But if the storage element is a mapped element, then the VTL instance issues a media movement command to the associated PTL to load the physical tape into the corresponding tape drive and if the move command is successful the virtual drive is associated with the physical tape drive. When the backup host sends a command to the virtual drive, if the virtual drive is associated with a virtual tape, then the virtual drive handles it. Else if the virtual drive is mapped to a physical tape drive, the command is relayed to the physical tape drive, the VTL instance receives the response from the physical tape drive for the command and sends the response back to the backup host. If a physical tape drive already had a physical tape loaded on the VTL instance start up, the virtual drive in the VTL instance gets automatically mapped to the physical tape drive.

When the VTL instance receives a media movement from a mapped virtual slot to an empty virtual drive, the VTL should be able know to which physical drive in the PTL the virtual drive needs to be mapped. This is done by maintaining an internal mapping of a virtual drive to a physical drive. For example a mapping could be like if virtual drive 1 receives a media load command for media from a mapped virtual slot, then virtual drive 1 is mapped to physical drive 1 in the associated PTL. Likewise for virtual drive 2 and physical drive 2. This is a static mapping and means that there is a 1:1 correspondence between the virtual drives and the physical drives in the PTL and the number of drives in the VTL instances is equal to the number of drives in the associated PTL. For example in FIG. 6, VD1 (601) would always be mapped to PD1 (607) and VD2 (602) would always be mapped to PD2 (608) when a media movement command is received by backup host (100) and if MS2 (606) is the source for the media movement

The number of virtual drives in a VTL instance can be more than the number of drives in the associated PTL. This has the obvious advantage that, even if all the drives in the PTL were mapped to virtual drives in the VTL instance, there would still be additional virtual drives available into which virtual tapes can be loaded. In such a case a dynamic mapping is applied where in when a mapping between a virtual drive and a physical drive is needed, a suitable empty physical drive from the associated PTL is selected for the mapping. The mapping is dynamic, since the same virtual drive can be mapped to another physical drive the next time, or can be associated with a virtual tape.

FIG. 8 is a flowchart explaining the process of loading a media into a virtual drive. Referring to FIG. 8, when a backup host loads a media into a virtual drive, if the element from which the media is to be loaded is a mapped element, then the virtual drive is mapped to the physical drive in the associated PTL as shown in block 802. The physical drive is determined by an internal state maintained in the virtual drive. A media load command is sent to the associated PTL to load the media from the source physical element into the physical drive as shown in block 804. If however the source element from which the media is to be loaded is a virtual element, the VTL instance handles the media load operation and loads the virtual tape from the source virtual element to the virtual drive as shown in block 803.

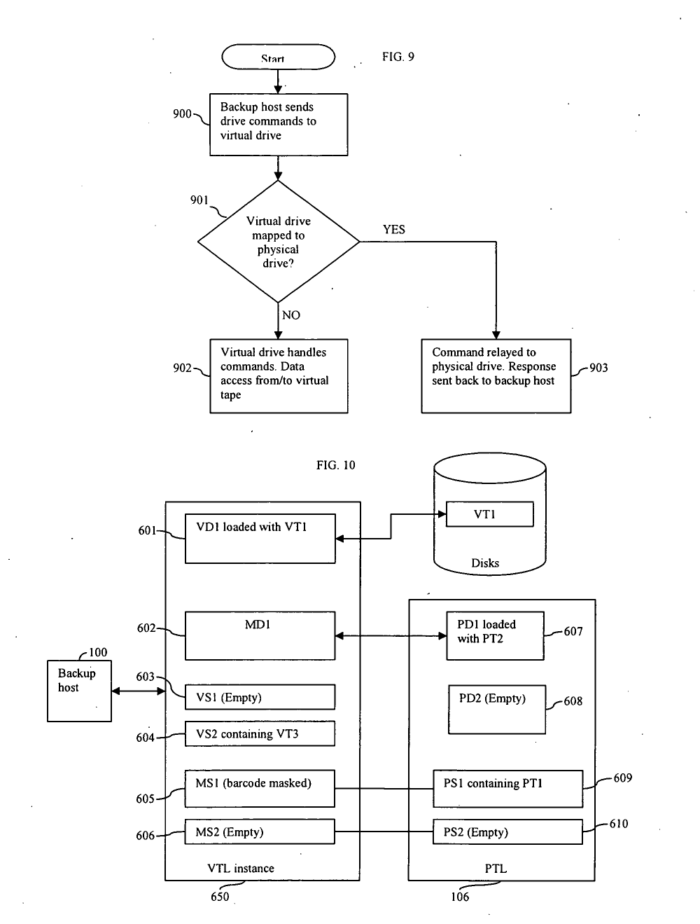

FIG. 9 is a flowchart explaining the process of servicing tape drive commands based on the media associated with the virtual drive. Referring to FIG. 9, the VTL instance receives tape drive commands for a virtual drive as shown in block 900. If the virtual drive is mapped to a physical drive, the command is relayed to the physical drive, the response received and the response sent back to the host (as shown in block 903). If however the virtual drive is loaded with a virtual tape, the VTL instance handles the drive command and sends the response back to the host. If the virtual drive contains no media, the virtual drive behaves as a mapped virtual drive by default.

FIG. 10 shows an example VTL instance configuration after the backup host loads the virtual drives. As shown in FIG. 10 and comparing with FIG. 6, virtual tape VT1 from slot VS1 (603) is loaded into virtual drive VD1 (601). VD2 (602) is now called MD1 (602) since the backup application tried to load the drive with PT2. The physical drive PD1 (607) is loaded with PT2 and MD1 (602) is mapped to PD1 (607). If for example VD1 (601) receives a data write command, the data is written to the virtual tape VT1 by VD1 (601). If however MD1 (602) receives a data write command, the write command is forwarded to PD1 (607) and the response is received by MD1 (602) and sent back to the backup host (100).

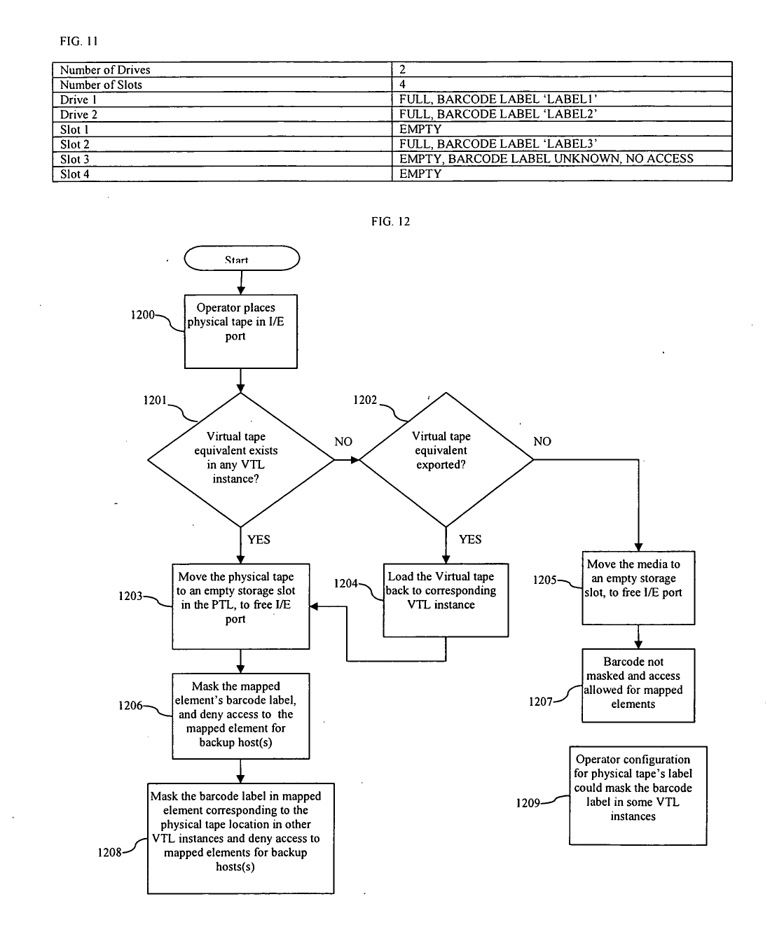

FIG. 11 illustrates the inventory returned to a backup host for the illustration in FIG.

### Import Operation in the First Embodiment

The operator from the VTL system control panel can move an exported virtual tape back into the VTL system. In such a case, to the backup host it would appear as if an operator has placed media in an I/E port of the VTL instance. An operator can also place a media into one of the I/E ports of a PTL. The media placed could be one which was never seen by the VTL system before or could be a prior exported tape. If the media was a prior exported tape, and if a virtual tape equivalent is still present in the system, the virtual tape is moved back into the VTL instance and the barcode label for the mapped element corresponding to the physical tape location is masked and access to that element is prevented for the backup host. To all other VTL instances present in the VTL system, the barcode label for the mapped element corresponding to the physical tape location is masked and access to the virtual element is denied. It should be noted that the same principle applies when a tape cartridge is placed manually by an operator in one of the storage slots of the library. If the media is one which the VTL system hasn't seen before or if the equivalent virtual tape is no longer available, the corresponding mapped element would indicate to a backup host that new media has been placed in the library.

FIG. 12 is a flow chart explaining the import operation. Referring to FIG. 12, an operator places a media in an I/E port of a PTL as shown in block 1200. As shown in block 1201, a check is made if a virtual tape in all VTL instances with a matching barcode label exists. If not present as shown in block 1202, a check is made in the virtual vault if a virtual tape with a matching barcode label was prior exported. If a virtual tape with a matching barcode label exists in the virtual vault, then the virtual tape is loaded back into the same VTL instance from which the virtual tape was exported as shown in block 1204. Once the virtual tape is imported into the VTL or if the virtual tape already exists in a VTL instance, a media movement command is sent to the PTL to move the physical tape into an empty storage slot in the PTL in order to free the I/E port for further media insertions/removal. If the media move operation succeeds barcode label is masked for all mapped elements in all VTL instances corresponding to the storage slot as shown in block 1206 and 1208. If the media move operation cannot be performed for example due to failure in the move operation or the non availability of an empty storage slot, barcode label is masked for all mapped elements in all VTL instances corresponding to the I/E port.

If no virtual tape exists either in any VTL instance or in the virtual vault, then a move command maybe sent to the PTL to move the media to an empty storage slot. If the media is known to the VTL system no barcode label masking is applied as shown in blocks 1205 and 1207. If the media barcode label is not known to the system, then the VTL system checks if the new media is a blank media and based on the operator's configuration the barcode label maybe masked.

### Eject Operation in The First Embodiment

Once the VTL instance decides to copy data from a virtual tape to a physical tape, either at the request of the backup host or via a policy configured by the operator, the data from the virtual tape is copied to the physical tape. When the backup host issues an eject command by sending a move command to move a virtual media out to the I/E port of the VTL instance, if the export operation hasn't been performed yet, the virtual library system performs the export operation, and thereafter moves the actual physical tape to the input/output ports in the PTL.

The VTL instance waits for the operator to remove the physical tape from the library eject port. Once the physical tape has been removed from the PTL, the virtual tape is removed from the VTL instance. Until the time the operator removes the physical tape from the associated PTL, the corresponding virtual tape would occupy the virtual input/output port in the VTL instance.

FIG. 13 is a flow chart explaining the export operation. It should be noted that the associated PTL might not have any I/E ports. In such cases the physical tape cannot be moved to the I/E port and has to be manually removed by the operator from the library. Referring to FIG. 13, in block 1300 a host sends an eject command to a VTL instance. The eject command basically is a media movement of a virtual tape from either a virtual drive element or a virtual storage slot to a virtual I/E element. The virtual tape is first moved to the virtual I/E port specified in the eject command as shown in block 1301. As shown in block 1302, the VTL instance checks if a physical tape with matching barcode label exists in the PTL associated with the VTL instance. This information can be retrieved by checking the barcode labels in the mapped element or can be received from the VTL server. If a physical tape with the matching barcode label cannot be found, the export operation cannot continue as shown in block 1310. If a physical tape with the matching barcode label is found in the associated PTL, then the VTL instance checks if the export operation needs to be performed, i.e. if data from the virtual tape was already copied to the physical tape and no data was written to the virtual tape after that time. If the data from the virtual tape needs to be copied to the physical tape, then the export operation is performed as shown in block 1304. The export operation would involve issuing a media movement command to the associated PTL to move the physical tape to an empty drive first. The barcode label is masked for all mapped elements corresponding to the drive. Once the export operation completes, a media movement command is sent to the associated PTL to move the physical tape to an empty I/E port. The barcode label for all mapped elements associated with the I/E port is masked and the barcode label for all mapped elements associated with the drive is unmasked. The VTL server or VTL instance waits for the physical tape to be removed from the associated PTL by an operator. Once removed the barcode label is unmasked for the I/E port, the virtual tape is removed from the VTL instance and moved to a virtual vault.

### 7. Second Embodiment of the Invention

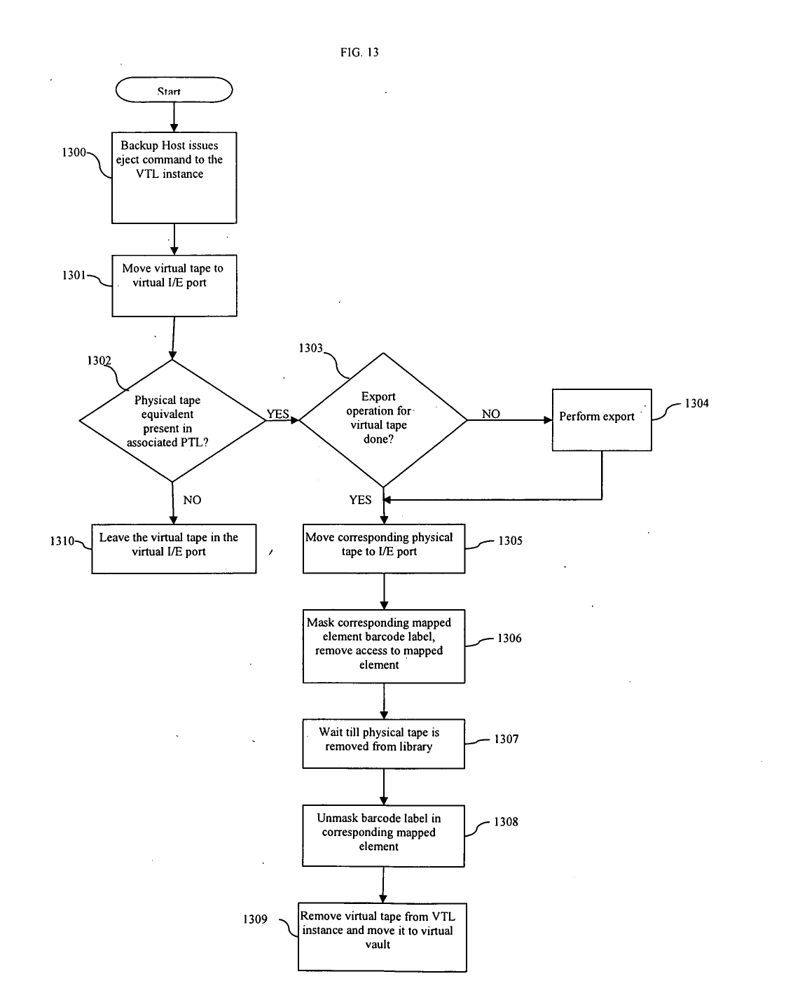

In a second embodiment of the invention, as in the first of the invention, the virtual elements and the mapped elements are combined to form a larger virtual library instance as shown in FIG. 14

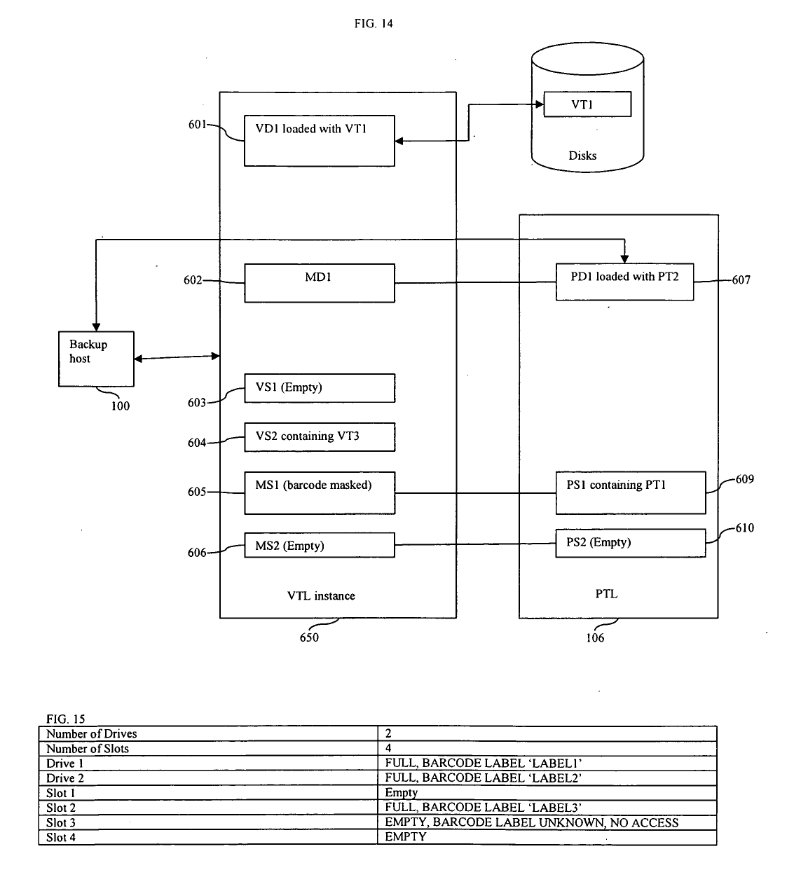

However as shown in FIG. 14 the backup host is connected and accesses the physical tape drive PD1 (607) directly. The element status reported for MD1 (602) as shown in the figure is such that the backup host thinks that PD1 (607) is actually a part of the VTL instance. This is achieved by reporting the same device identifier that the tape drive would report to the backup host when MD1 is queried for its status. Providing direct access to the physical tape drives is useful for faster access to the physical tape drives than that is provided in the first embodiment since in the second embodiment, the physical tape drives are directly accessed by the backup host. FIG. 15 is an illustration of the inventory returned to a backup host for the illustration in FIG. 14.

The second embodiment of the invention would be applicable to backup hosts of type ‘A’. In this case the backup host is configured such that virtual tapes are moved between virtual elements and physical tapes are moved between mapped elements. Although the backup host has no knowledge that the elements its dealing with are virtual elements or mapped elements, and treats all elements as physical elements, backup hosts can be configured to associate storage slots with tape drives and the movement of media is restricted between these storage slots and tape drive association. So the virtual drives can be configured to be associated to the virtual storage slots, and the mapped virtual tape drives can be associated with the mapped virtual storage slots in the backup host's application.

When a media movement command is received by the VTL instance, if the movement is between virtual elements, the movement is performed by the VTL instance and if the movement is between mapped elements, the command is relayed to the associated PTL. If the VTL instance receives a command to move media between a virtual element and a mapped element, the command is rejected and an error is returned back to backup host. For example referring to FIG. 14, media movement can only be performed between virtual drive VD1 (601) and virtual slots VS1 (603) and VS2 (604). Similarly media movement commands can be performed between mapped drive MD1 (602) and mapped storage slots MS1 (605) and MS2 (606). A media movement command for example between MD1 (602) and VS2 (604) would be an error in this embodiment.

There is an exception to this when considering I/E ports. Although backup hosts can support association of drives to slots, the I/E ports would generally have no such association. The virtual I/E ports are created such that there is a one to one mapping with the I/E ports of the associated PTL. However the virtual I/E ports behave as in, the first embodiment, where in the type of media in the virtual I/E port determines its association

### Eject Operation for the Second Embodiment

Eject operation is performed as in the first embodiment

### Import Operation for the Second Embodiment

The operator from the virtual tape control panel can move a virtual tape, which was exported back into the VTL system. The virtual tape cannot be shown as placed in the virtual I/E port in this embodiment, since there is the likelihood of the backup host trying to move the virtual tape to one of the mapped elements. The virtual tape is moved into one of the virtual slots the VTL instance. It would seem to the backup host that a media was moved by the operator to one of the storage slots and the backup host updates its inventory of the library. If a free virtual slot is not available, the operation would fail.

An operator can also place a media into one of the I/E ports of the PTL. The media placed could be one, which was never seen by the VTL system before or could be a prior exported tape. If the media was a prior exported tape, and if the virtual tape equivalent is still present in the system, the virtual tape is moved back into the VTL instance and the barcode label for the mapped element corresponding to the physical tape location is masked and access to that element is prevented for the backup host. To all other VTL instances present in the VTL system, the barcode label for the mapped element corresponding to the physical tape location is masked and access to the virtual element is denied.

Similar to the first embodiment, the physical tape can be moved to one of the empty storage slots to free up the I/E ports. Depending on the operator's configuration for a PTL in the VTL system, the media barcode label could be used to figure out which empty storage slot to place the media in. For example the configuration of the PTL could be that a media with label prefix ‘AAA’ should be placed in storage slots 1-10. This means that if the VTL system sees a media with label AAA001 it would try to place it in an empty slot between 1 and 10. It should be noted that this example is just one instance of how the VTL system decides which empty storage slot to place the media in. Other operator configuration options can be derived to make the decision.

If the physical tape is unknown to the VTL system, or if the equivalent virtual tape is no longer present, the VTL system tries to move the tape into one of the empty storage slots in the associated PTL. If there are no empty storage slots available, access to the corresponding virtual I/E port is not available to the backup host, till the time the media is not moved into a free storage slot and the barcode label is masked in the virtual element

Once moved to a free storage slot, the barcode label is unmasked in the corresponding mapped element in all VTL instances and access is allowed to the corresponding mapped element in all VTL instances.

A further modification to the second embodiment is to return the virtual nature of an element when the status of an element is queried. Virtual elements specify that they are virtual elements, and mapped elements specify that they are physical elements. That way the backup host knows about which elements are virtual and which elements are physical and can ensure that media movement between virtual elements and physical elements do not happen. This however would mean that the backup software, the command/response protocol and the VTL system agree on a common method of specifying these and also that the backup host handle virtual elements separately from physical elements. Future command/response protocol standards and backup hosts can support this.

### 8. Third Embodiment of the Invention

In a third embodiment of the invention, the virtual elements belong to a VTL instance, and the mapped elements belong to a mapped VTL instance. The third embodiment of invention is suitable for backup hosts of type ‘B’ if the second embodiment is preferred to that of the first embodiment.

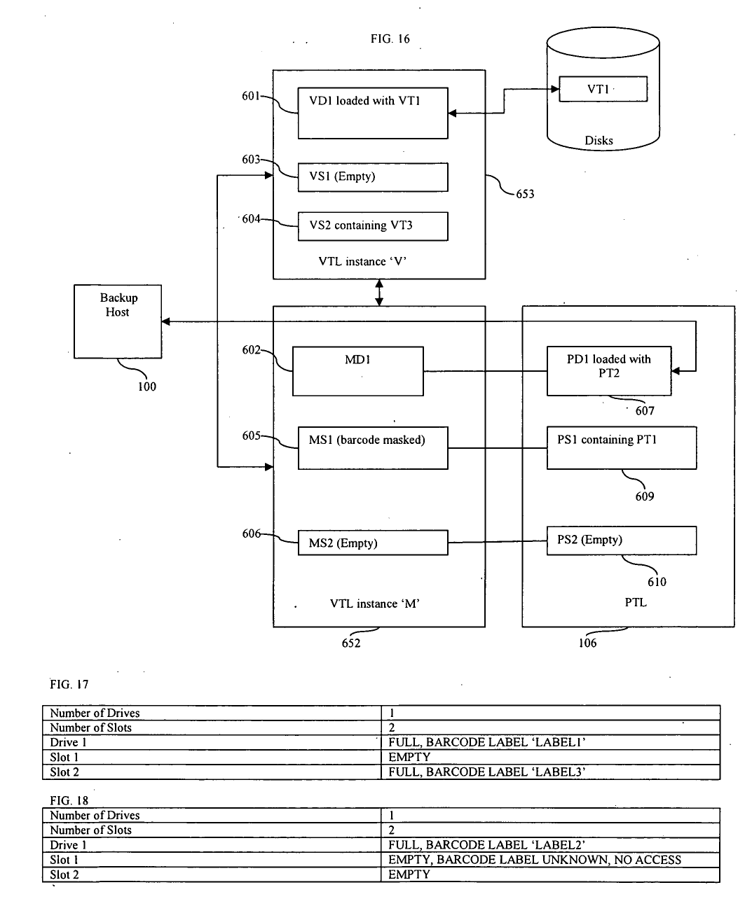

As in the second embodiment, the physical tape drives are accessed directly and can be seen in FIG. 16 where the backup host (100) has direct access to tape drive PD1 (607). The element status reported for mapped drive MD1 (602) as shown in the figure is such that the backup host thinks that physical drive PD1 (607) is actually a part of the VTL instance. This is achieved by reporting the same device identifier that the tape drive would report to the backup host when MD1 is queried for its status. Providing direct access to the physical tape drives is useful for faster access to the physical tape drives than that is provided in the first embodiment since in the second and third embodiments, the physical tape drives are directly accessed by the backup host

If a media barcode label of a virtual tape is the same as that of the a physical tape, then in the mapped VTL instances, the corresponding mapped element's barcode label is masked and access to the mapped element is denied to a backup host. The backup host can access the physical library tape drives directly, but the media movement between the PTL elements can only be performed under the control of the mapped VTL instance. The mapped VTL instance and the VTL instance pair appear as separate tape libraries to a backup host. As an example in VTL instance ‘M’ (652) barcode label in MS1 (605) is masked and access denied since VTL instance ‘V’ (653) has VD1 (601) with a virtual tape VT1 with a matching barcode label.

FIG. 17 illustrates the inventory of VTL instance ‘V’ returned to a backup host when queried and FIG. 18 illustrates the inventory of VTL instance ‘M’ returned to a backup host when queried.

### Eject operation in the third embodiment

Once the VTL instance decides to copy data from a virtual tape to a physical tape, either at the request of the backup host or via a policy configured by the operator, the data from the virtual tape is copied to the physical tape. When the backup host issues an eject command to move a virtual media out to the eject port of the VTL instance, if the export operation hasn't been performed yet, the VTL instance performs operation, and thereafter the physical tape is moved to an empty I/E port in the associated PTL.

The system waits for the operator to remove the physical tape from the library eject port. At this point the virtual tape is now removed from the VTL instance. Until the time the operator removes the physical tape from the associated PTL, the corresponding virtual tape would occupy the virtual I/E port in the VTL instance. Until the time the operation removes the physical tape from the associated PTL, in the mapped VTL instance, the mapped I/E port is masked and access to that port is denied to the backup host.

### Import Operation in the Third Embodiment

The operator from the virtual tape control panel can move a virtual tape, which was exported back into the VTL system. In such a case, the virtual tape would appear as if the operator has placed a media in an I/E port for the VTL instance. An operator can also place a media into one of the I/E ports of the PTL. The media placed could be one, which was never seen by the VTL system before or could be a prior exported tape. If the media was a prior exported tape, and if the virtual tape equivalent is the virtual vault, the virtual tape is moved back into the VTL instance and in all mapped VTL instances associated with the PTL, the barcode label is masked for the mapped element corresponding to the physical tape location and access is denied for the mapped element to a backup host.

If the media is one which the VTL system hasn't seen before or if the equivalent virtual tape is no longer available, the corresponding mapped element in the mapped virtual instance(s) would indicate to a backup host that new media has been placed in the library. The physical tape could be moved into a free storage slot in the PTL to free up the I/E port

### 9. Remapping of Mapped Elements with Barcode Labels Masked

A host might ignore that access to mapped elements whose barcode labels are masked and since in the element status information returned for mapped elements with masked barcode labels it would indicate to a host that media is absent in the mapped element a host might try to insert media from another location into the mapped element. In such cases if access to the mapped element for media insertion was denied due to masking of the barcode label, as a special case remapping of the mapped element can be done as follows:
locate a second mapped element for which the corresponding physical element has no media,
change the mapping for the first mapped element to the physical element the second element corresponds to,
change the mapping the second mapped element to the physical element the first mapped element originally corresponded to,
relay the media movement command to the associated PTL to move the media between the physical elements the source and destination mapped elements correspond to

The remapping is allowed for mapped elements corresponding to storage slots and I/E ports. In case the mapped element corresponds to a drive element, the command is terminated with error

### 10. Device and Element Reservations

In order to serialize access to a device from multiple hosts, devices normally support the concept of reservation. A device as a whole or a element such a storage element within the device can be reserved by a host for exclusive use of the device/element and can be released after the exclusive use. In the embodiments of the inventions since different hosts can access the same device/element via different VTL instances device reservation/release commands can be directed to the same physical device via the mapped elements. The VTL system manages reservations as follows;
On receipt of a reserve command by a VTL instance for a mapped element corresponding to a physical tape drive in an associated tape library, the following steps are performed:
   If the physical tape drive the mapped element corresponds to is reserved by another other host via this or any other VTL instance, the reservation command is failed and an error is returned to the host, else
   the reservation command is forwarded to the physical tape drive, the response is received and if response indicates a successful command completion, the physical tape drive is marked as reserved by the host via the VTL instance. Every other VTL instance is notified of the reservation
On receipt of a reserve command by a VTL instance directed to the virtual medium changer of the VTL instance and if the VTL instance has mapped elements, the following steps are performed:
   If the physical tape library is reserved by another host via this or any other VTL instance, the reservation command is failed, else
   the reservation command is forwarded to the physical medium changer device of the associated physical tape library, the response is received and if the response indicates a successful command completion, the physical tape library is marked as reserved by the host via the VTL instance. Every other VTL instance is notified of the reservation.
On receiving any command which can be affected if reservations are in effect, and if reservations are in effect and if the device is reserved by another host via this or another VTL instance and if this command cannot be completed due the reservation by another host, the command is terminated with error and the error response indicating a reservation conflict is sent back to the host

### 11. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents. Also, the various aspects, features, components and/or embodiments of the present invention described above may be embodied singly or in any combination in a data storage system.

I claim:

1. A method for facilitating integrating a virtual tape library with a physical tape library comprising:
associating a virtual tape library instance with a physical tape library accessible by the virtual tape library instance via a network;
creating a plurality of mapped elements in the virtual tape library instance, each mapped element corresponding to a physical element in the associated physical tape library;
updating status information of a mapped element when the status information of its corresponding physical element changes;
receiving a media movement command from a host by a virtual tape library instance,
if the media movement command is between two virtual elements, handling the media movement within the virtual tape library instance, else
if the media movement command is between two mapped elements, relaying the media movement command to the associated physical tape library, receiving the command response, sending the received response to the host and updating the status information of the mapped elements involved in the media movement command;
receiving a drive command from a host directed to a virtual drive in a virtual tape library instance,
if the virtual drive is associated with a virtual tape, handling the drive command within the virtual tape library instance, else
if the virtual drive is mapped to a physical tape drive in the associated physical tape library, relaying the drive command to the physical tape drive, receiving the command response and sending the received response to the host; and
receiving element status command from a host by a virtual tape library instance,
if the element status command is for the status of a virtual element, returning the status of the virtual element as maintained by the virtual tape library instance,
if the element status command is for a mapped element, returning the status of the corresponding physical element in the associated physical tape library as maintained by the virtual tape library.

2. The method in claim 1, wherein the step of updating the status information of mapped element further comprises of:
updating the mapped element's information with the presence or absence of media in the corresponding physical element;
updating the mapped element's information with the media identifier of the media in the corresponding physical element;
updating status for masking of barcode label.

3. The method in claim 2, wherein the step of updating status for masking of barcode label comprises of:
determining if a virtual tape in any virtual tape library instance has a matching barcode label with that of the physical tape in the corresponding physical element and if a virtual tape is found, updating the mapped element status for masking barcode label information to true;
determining if the physical tape in the physical element contains blank media and if true updating the mapped element status for masking barcode label information to true.

4. The method in claim 1, wherein the step of returning element status for a mapped element further comprises of:
determining if the barcode label for the mapped element needs to be masked and if true then returning in the element status response information that,
the mapped element does not contain any media,
access to the mapped element for media insertion and media removal is denied,
barcode label for the media in the mapped element is unknown.

5. The method in claim 1, wherein the step of receiving media movement command from a host further comprises of:
determining if the media movement is between two virtual elements and the destination of the media movement is a virtual import/export element and if true,
performing the media movement within the virtual tape library instance, locating a physical tape with a matching barcode label from among the physical elements the mapped elements correspond to,
determining if the data from the virtual tape needs to be copied to a physical tape and if true,
loading the located physical tape into an empty tape drive in the associated physical tape library
masking the barcode label for the mapped element corresponding to the tape drive, copying the data from the virtual tape to the physical tape loaded in the tape drive,
moving the physical tape to an empty import/export element in the physical tape library and unmasking the barcode label for the element from which the physical tape was moved,
masking the barcode label for all mapped elements corresponding to the import/export element in all virtual tape library instances,
waiting for an operator to remove the physical tape from the associated physical tape library and then unmasking the barcode label for all mapped elements corresponding to the import/export element in all virtual tape library instances and then removing the virtual tape from the virtual tape library instance and moving the virtual tape to a virtual vault.

6. The method in claim 1, wherein the step of receiving media movement from a host further comprises of:
determining if the source element in the media movement is a virtual element and the destination element is a mapped element and if true,
locating an empty virtual element in the virtual tape library system,
mapping the located virtual element to the physical element corresponding to the destination mapped element,
removing the mapping for the destination mapped element,
performing the media movement within the virtual tape library instance between the source and destination elements specified in the command.

7. The method in claim 6, wherein the destination mapped element corresponds to a storage slot.

8. The method in claim 6, wherein the destination mapped element corresponds to an import/export element.

9. The method in claim 1, wherein the step of receiving media movement command from a host further comprises of:
determining if the source element in the media movement is a mapped element and the destination element is a virtual element and if true,
locating a mapped element for which the corresponding physical element contains no media,
mapping the destination virtual element to corresponding physical element of the located mapped element,
removing the mapping for the located mapped element,
relaying the media movement command to the associated physical library for media movement between the physical elements corresponding to the source and destination mapped elements, receiving the command response and sending the response to the host.

10. The method in claim 9, wherein the destination virtual element corresponds to a storage slot.

11. The method in claim 9, wherein the destination virtual element corresponds to an import/export element.

12. The method in claim 1, wherein the step of receiving media movement command from a host further comprises of:
determining if the destination of the media movement is a virtual drive element and if true,
if the source element for the media movement is a virtual element, the virtual drive is associated with the virtual tape, else
if the source element for the media movement is a mapped element, mapping the virtual drive to a physical drive in the associated physical tape library, relaying the media movement command to the associated physical tape library, receiving the command response and sending the response to the host.

13. The method in claim 1, wherein the step of receiving media movement command from a host further comprises of:
determining if the destination element of the media movement command is a mapped element and if barcode label has been masked for the element and if true,
locating a second mapped element for which the corresponding mapped element has no media,
changing the mapping for the destination element to the corresponding physical element of the second mapped element,
changing the mapping for the second destination element to the physical element the destination element originally corresponded to,
relaying the media movement command to the associated physical library for media movement between the physical elements corresponding to the source and destination mapped elements, receiving the command response and sending the response to the host.

14. The method in claim 13, wherein the destination mapped element corresponds to a storage slot.

15. The method in claim 13, wherein the destination mapped element corresponds to an import/export element.

15. The method in claim 1, wherein the step of receiving media movement command from a host further comprises of:
determining if the destination element of the media movement command is a mapped element corresponding to a physical drive and if barcode label has been masked for the mapped element and if true,
terminating the command and sending an error response to the host.

16. A method comprising:
creating a first virtual tape library instance comprising of a plurality of virtual elements;
creating a second virtual tape library instance comprising of plurality of mapped elements;
maintaining an association between the first virtual tape library instance and the second virtual tape library instance.

17. The method in claim 16, further comprising of:
receiving media movement command from a host by the first virtual tape library instance and if the destination for the media movement is a virtual import/export element,
performing the media movement within the first virtual tape library instance, locating a physical tape with a matching media identifier in the physical tape library associated with the second virtual tape library instance and if found,
issuing a media movement command to the physical tape library associated with the second virtual tape library instance to load the located physical tape into an empty tape drive in the physical tape library,
masking the barcode label and media information for all mapped elements in all virtual tape library instances corresponding to the physical tape drive
coping data from the virtual tape in the virtual import/export element of the first virtual tape library instance to the physical tape,
moving the physical tape to an empty import/export element in the physical tape library and unmasking the barcode label for the element from which the physical tape was moved,
masking the barcode label and media information for all mapped elements corresponding to the import/export element in all virtual tape library instances, waiting for an operator to remove the physical tape from the associated physical tape library and then unmasking the barcode label and media information for the mapped element corresponding to the import/export element and then removing the virtual tape from the first virtual tape library instance and moving the virtual tape to a virtual vault.

18. A method for device reservation comprising of:
receiving a device reservation command from a host for a mapped element,
determining if the corresponding physical element is reserved by another host or by a mapped element in another virtual tape library instance and if true rejecting the reservation command with an error, else
issuing an reservation command for the corresponding physical element and receiving the status of the reservation command and on a successful reservation of the physical element marking the element as reserved by the host via the virtual tape library instance;
receiving a device reservation command from a host for a virtual tape library instance containing mapped elements,
determining if the physical tape library associated with the virtual tape library instance is reserved by another host or by another virtual tape library instance and if true rejecting the reservation command with an error, else
issuing a reservation command to the associated physical tape library and receiving the status of the reservation command and on a successful reservation of the physical tape library, marking the physical tape library as reserved by the host via the virtual tape library instance.

19. The method in claim 18, wherein the step of marking an element as reserved by a host via a virtual tape library instance further comprises of:
informing all other virtual tape library instances associated with the same physical tape library about the reservation of the physical element and each virtual tape library instance updating the reservation status of the mapped element corresponding to the physical element.

20. The method in claim 18, wherein the step of marking a physical tape library as reserved further comprises of:
informing all other virtual tape library instances associated with the physical tape library about the reservation of the physical tape library and each virtual tape library instance updating its reservation status of the physical tape library.

21. A method for handling media insertion into a physical tape library comprising of:
polling the import/export elements and storage slots of the physical tape library for media insertions;
if the media inserted was prior exported performing the steps comprising of:
identifying the virtual tape library instance from which the export operation was completed,
locating a virtual tape with a matching barcode label in the virtual tape library and if not found locating a virtual tape with a matching barcode label in the virtual vault and if found in the virtual vault, moving the virtual tape in to a virtual element of the virtual tape library instance,
if a virtual tape with a matching barcode label is found, masking the barcode label for the all mapped elements in all virtual tape library instances corresponding to the physical element where the media was inserted;
else if the media wasn't prior exported and is determined to be a blank media or reusable media then masking the barcode label for all mapped elements in all virtual tape library instances corresponding to the physical element where the media is inserted.
